(19) United States
(12) Patent Application Publication
(10) Pub. No.: US 2023/0359746 A1
(43) Pub. Date: Nov. 9, 2023

(54) SYSTEMS AND METHODS FOR SHIFT LEFT TESTING

(71) Applicant: JPMORGAN CHASE BANK, N.A., New York, NY (US)

(72) Inventors: Juan WANG, Dublin, OH (US); Michelle BELLIDO, Buffalo Grove, IL (US); Roman EISENBERG, New York, NY (US); Leonid TSVAYBERG, New York, NY (US); Indeevara H. DE SILVA, Lewis Center, OH (US)

(21) Appl. No.: 18/311,482

(22) Filed: May 3, 2023

Related U.S. Application Data
(60) Provisional application No. 63/364,157, filed on May 4, 2022.

(51) Int. Cl. G06F 21/57; G06F 11/36

(52) U.S. Cl. CPC G06F 21/577; G06F 11/3688; G06F 2221/033

(57) ABSTRACT

Systems and methods for shift-left testing are disclosed. In one embodiment, a method may include an automation pipeline: receiving code for shift-left testing; testing the code with unit tests; testing a plurality of components of the code with component tests; testing the code with contract tests; testing the code with integration tests; deploying the code to an end-to-end testing environment and testing the code with end-to-end automation tests; scanning the code for security vulnerabilities; deploying the code to an end-to-end testing environment and performing production validation testing on the code; and deploying the code to a production environment.

### RELATED APPLICATIONS

This application claims priority to, and the benefit of, U.S. Provisional Patent Application Ser. No. 63/364,157 filed May 4, 2022, the disclosure of which is hereby incorporated, by reference, in its entirety.

### BACKGROUND OF THE INVENTION

### 1. Field of the Invention

Embodiments are generally directed to systems and methods for shift-left testing.

### 2. Description of the Related Art

There are several issues with software testing that contribute to lower stability, efficiency, and speed to market. For example, a good percentage of production incidents are due to code defects and insufficient testing, the culture of automated and continuous testing, and particularly in-sprint test automation, has not been widely adopted, and automation is perceived to be time consuming and costly the appreciation of longer-term benefits are not considered during sprint planning. Without automated test coverage, which is continuously executed, each new feature delivery is bound to take longer.

Traditional practices on software development—where requirements are on the left side of the plan and development and testing are on the right side—are unable to handle changing expectations and requirements.

### SUMMARY OF THE INVENTION

Systems and methods for shift-left testing are disclosed. In one embodiment, a method for shift-left testing may include: (1) receiving, at an automation pipeline, code for shift-left testing, wherein the code comprises a plurality of code components; (2) testing, by the automation pipeline, the code with unit tests, wherein the unit tests comprise narrowly-scoped tests that exercise units of the code to verify proper behavior; (3) testing, by the automation pipeline, the plurality of components of the code with component tests, wherein the component tests exercise the plurality of components of the code in isolation from each other; (4) testing, by the automation pipeline, the code with contract tests, wherein the contract tests two code components for compatibility and communication; (5) testing, by the automation pipeline, the code with integration tests, wherein the integration tests integration of the plurality of components with each other; (6) deploying, by the automation pipeline, the code to an end-to-end testing environment and testing the code with end-to-end automation tests, wherein the end-to-end automation tests exercise the code from start to finish; (7) scanning, by the automation pipeline, the code for security vulnerabilities; (8) deploying, by the automation pipeline, the code to an end-to-end testing environment and performing production validation testing on the code, wherein the production validation testing is executed on a plurality of threads; and (9) deploying, by the automation pipeline, the code to a production environment.

In one embodiment, the component tests are limited to a system under test.

In one embodiment, the security vulnerabilities comprise encryption vulnerabilities and third party software development kit violations.

In one embodiment, the production validation testing is performed on a first browser version in a first thread, and a second browser version in a second thread.

In one embodiment, the production validation testing is performed on a first operating system in a first thread, and a second operating system in a second thread.

In one embodiment, the method may also include isolating, by a bot, failures due to a test framework or environmental instability from failures due to code issues.

In one embodiment, the bot is trained with historical data.

According to another embodiment, a system may include: a code repository comprising code for shift-left testing, the code comprising a plurality of components; an automation pipeline comprising a unit testing module, a component testing module, a contract testing module, an integration testing module, an end-to-end automation testing module, and a security scanning module; an end-to-end staging environment; a production staging environment; and a production environment. The automation pipeline is configured to receive the code from the code repository, to test the code with unit tests, wherein the unit tests comprise narrowly-scoped tests that exercise units of the code to verify proper behavior, to test the code with component tests, wherein the component tests exercise the plurality of components of the code in isolation from each other, to test the code with contract tests, wherein the contract tests two code components for compatibility and communication, to test the code with integration tests, wherein the integration tests integration of the plurality of components with each other, to deploy the code to the end-to-end testing environment and test the code with end-to-end automation tests, wherein the end-to-end automation tests exercise the code from start to finish, to test the code for security vulnerabilities; to deploy the code to the production staging environment and to perform production validation testing on the code, wherein the production validation testing is executed on a plurality of threads, and to deploy the code to the production environment.

In one embodiment, the component tests are limited to a system under test.

In one embodiment, the security vulnerabilities comprise encryption vulnerabilities and third party software development kit violations.

In one embodiment, the production validation testing is performed on a first browser version in a first thread, and a second browser version in a second thread.

In one embodiment, the production validation testing is performed on a first operating system in a first thread, and a second operating system in a second thread.

In one embodiment, a bot executed in the automation pipeline isolates failures due to a test framework or environmental instability from failures due to code issues.

In one embodiment, the bot is trained with historical data.

According to another embodiment, a non-transitory computer readable storage medium, may include instructions stored thereon, which when read and executed by one or more computer processors, cause the one or more computer processors to perform steps comprising: receiving, from a code repository, code for shift-left testing, wherein the code comprises a plurality of code components; testing the code with unit tests, wherein the unit tests comprise narrowly-scoped tests that exercise units of the code to verify proper behavior; testing the plurality of components of the code with component tests, wherein the component tests exercise the plurality of components of the code in isolation from each other; testing the code with contract tests, wherein the contract tests two code components for compatibility and communication; testing the code with integration tests, wherein the integration tests integration of the plurality of components with each other; deploying the code to an end-to-end testing environment and testing the code with end-to-end automation tests, wherein the end-to-end automation tests exercise the code from start to finish; scanning the code for security vulnerabilities; deploying the code to an end-to-end testing environment and performing production validation testing on the code, wherein the production validation testing is executed on a plurality of threads; and deploying the code to a production environment.

In one embodiment, the component tests are limited to a system under test.

In one embodiment, the security vulnerabilities comprise encryption vulnerabilities and third party software development kit violations.

In one embodiment, the production validation testing is performed on a first browser version in a first thread, and a second browser version in a second thread.

In one embodiment, the production validation testing is performed on a first operating system in a first thread, and a second operating system in a second thread.

In one embodiment, the non-transitory medium may also include instructions stored thereon, which when read and executed by one or more computer processors, cause the one or more computer processors to isolate failures due to a test framework or environmental instability from failures due to code issues.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for shift-left testing according to an embodiment;

FIG. 2 illustrates a method for shift-left testing according to an embodiment;

FIG. 3 depicts an exemplary computing system for implementing aspects of the present disclosure.

### DETAILED DESCRIPTION OF PREFERRED EMBODIMENTS

Embodiments generally relate to systems and methods for shift-left testing.

Embodiments may provide component tests that enable a product owner and an engineer to verify component behavior for correctness.

Embodiments may provide contract tests that may ensure that two separate code components that need to talk to each other are compatible.

Component tests and contact tests may provide opportunities to “shift-left” and rely less on the more expensive forms of testing in the integrated and quality assurance environments. “Shift-left” is a practice intended to find and prevent defects early in the software delivery process. This practice moves to the left as early in the lifecycle as possible.

In embodiments, product teams may define requirements as test case definitions that can be consumed by the test automation frameworks. This may remove any ambiguity of the requirements definition and “shift-left” in test automation, improving agility.

Product teams may: write tests in a Domain Specific Language (e.g., Gherkin) as part of Acceptance Criteria (AC) and Definition of Ready (DOR); ensure the automation scripts are part of continuous integration/continuous deployment pipeline and enforced on each code commit; ensure that automation testing results become part of the Story/EPIC Definition of Done (DOD); run automation scripts as part of regression; increase the level of UAT (User Acceptance Testing) automation testing and sign-offs; and/or may engage in pilot/production pre-live validation.

Engineering team may: improve Unit Test Coverage (UTC); introduce mutation testing to validate the value of unit test assertions; increase the level of component testing automation; establish practice of testing running components on CI/CD pipelines using service simulators/mocks; adopt API (Application Programming Interface) testing for service-based architecture; perform user interface component testing on a skeleton (shell app) or full application; and/or adopt In-Sprint automation.

Product and Engineering teams may: define customer journey end to end test that will be executed on the full application; establish a practice of running and validating full regression (all known functionality) and newly automated tests introduced with new features; may run smoke suite regression pack after every deployment to ensure that every change is fully tested (e.g., this may be run against simulated data); run full regression pack once a day to ensure that end to end against the test environment is in a working state; run full regression packs under 30 minutes by utilizing cloud's capabilities; perform production validation testing (e.g., every new feature needs to include the necessary Production Validation Accounts to ensure that all new functionality can be validated via automation in production environment post deployment but before opening it up for general availability); and/or run full regression pack as production verification testing against production environments.

Embodiments may provide some or all the following technical advantages: reduce duplication of tests while defining customer flows; provide an automated acceptance process that reduces manual effort in environment setup and feature execution; fewer defects due to in-sprint automation; identify and resolve functional defects at earlier part of delivery cycle; reduce troubleshooting time; improve code quality; reduction of change lead time; improve engineering experience as developers can commit code with confidence with low to no risk of introducing cross impact breaks; provide traceable test coverage (e.g., the total number of automated test cases and percent of automated test cases in comparison to total number of test cases. This needs to be collected into single Automation Inventory Tracking System. This will also enable the Engineering teams to adopt risk-based strategy on test coverage for isolated code changes) deliver releases with in-sprint automation (e.g., verification by comparison of test case creation execution vs lower and prod environment deployments of the code); provide continuous test executions (e.g., frequency, duration, success rate); enable more exploratory ad hoc test simulating different customer personas and the journeys they go through on the app; increase the “Hours of Coding Effort” for the engineering teams, etc.

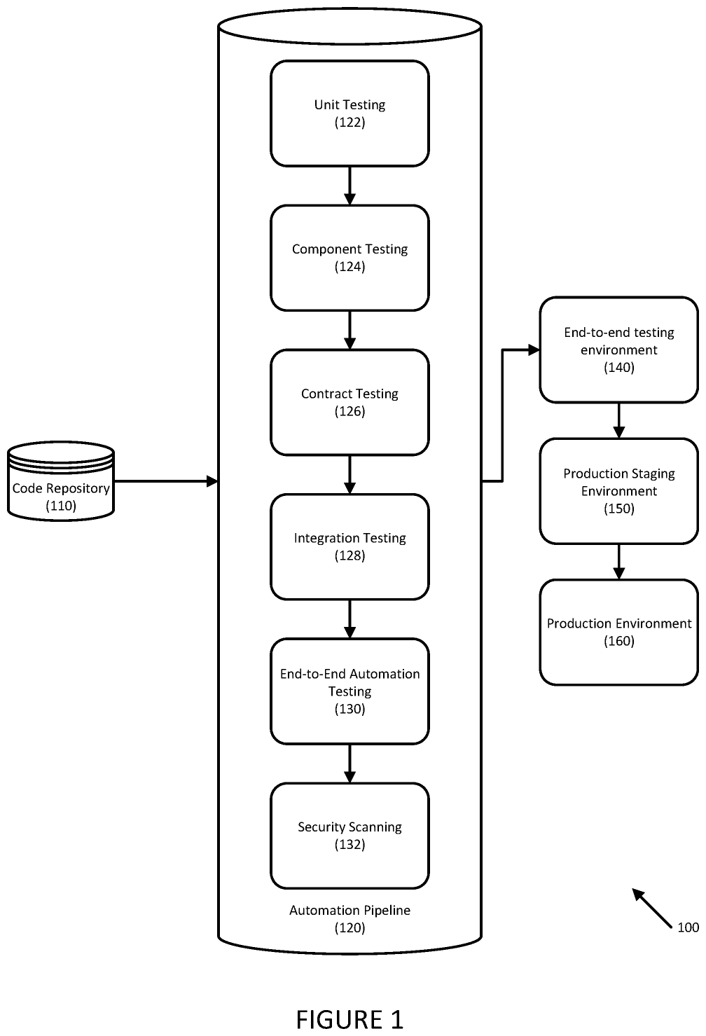

Referring to FIG. 1, a system for shift-left testing is disclosed according to an embodiment. System 100 may include code repository 110, which may be part of a continuous integration/continuous deployment process.

The code may include a plurality of code components and code units.

Code submitted to code repository 110 may be provided to automation pipeline 120. Automation pipeline 120 may include a plurality of testing modules, including unit testing module 122, component testing module 124, contract testing module 126, integration testing module 128, end-to-end automation testing module 130, and security scanning module 132.

Unit testing module 122 may execute one or more unit tests on the code. For example, unit tests may be narrowly-scoped tests that exercise the smallest pieces of testable code to verify proper behavior. An example of a unit test is a test that test the JavaScript function of the code.

Component testing module 124 may execute one or more component tests on the code. For example, component tests are functional tests on an isolated feature and are oftentimes executed against mocked data. For example, “login” and “account dashboard” are two different components and may be tested in isolation.

Contract testing module 126 may execute one or more contract tests. For example, contract tests may test two separate components in the code that are compatible and can communicate with one other. Contract testing may test integrated components in isolation to ensure that integrated components conform to a shared agreement, such as PACT, Spring Cloud Contract, etc. Examples of contract tests include testing contracts between services and a user interface, testing contracts between a user interface and an experience center to retrieve data, etc.

Integration testing module 128 may test the integration of components with each other. For example, integration tests may test that all user interface components interface correctly together, that the user interface components integrates with services, etc. A functional integration test of multiple components may represent a customer journey flow and may be executed on mocked data.

End-to-end automation testing module 130 may execute one or more end-to-end automation tests on the code. In one embodiment, the code may be deployed to end-to-end testing environment 140 for end-to-end automation testing. End-to-end testing environment may provide quality assurance and performance testing. For example, end-to-end automation tests may exercise the full stack of the application, code starting with an API, and may test against live services. For example, an end-to-end test may have a customer log in, select an account, and view account data. The end-to-end testing may test components from the user interface to the backend databases.

Security scanning module 132 may execute one or more security scans on the code. For example, security scans may test the code for vulnerabilities, such as security flaws, glitches, or weaknesses that could be exploited by an attacker, threat scanning for encryption vulnerabilities, third party software development kit violations, etc.

Any suitable unit tests, component tests, contract tests, security tests and end-to-end automation tests may be used as is necessary and/or desired.

If the code fails any of the tests, the code will not progress through the automation pipeline. The developer may be notified of the failure. In embodiments, the code may be returned to the code repository for revision.

If the code passes the tests, it may be deployed to production staging environment 150, where it may undergo production validation testing. If the code passes the production validation testing, it may then be deployed or made available in production environment 160.

In one embodiment, production validation testing may be set up for continuous execution of multiple threads, such as different browser versions, different operating systems, etc.

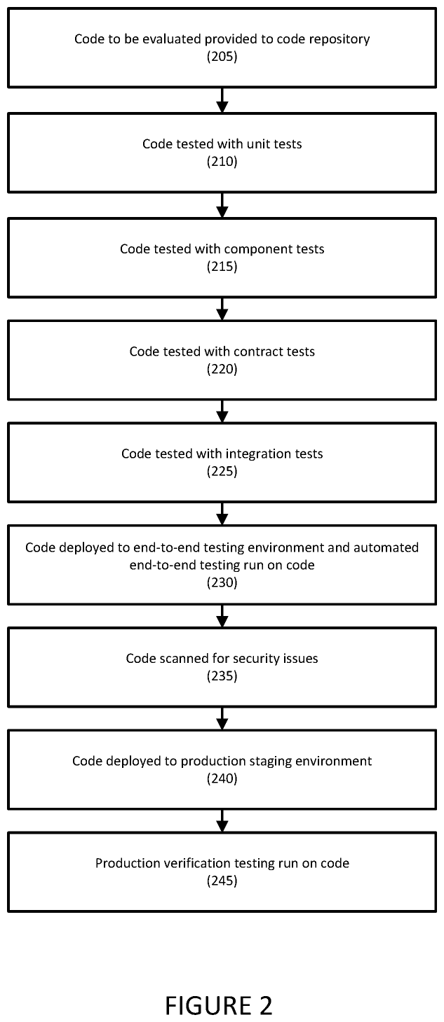

Referring to FIG. 2, a method for shift-left testing is disclosed according to an embodiment.

In step 205, code to be evaluated as part of shift-left testing may be provided to code repository. For example, as code is checked in to the data repository, the code may be provided to an automation pipeline. In one embodiment, a computer program, such as a bot, may be provided that orchestrates the testing in the pipeline. In one embodiment, the bot may also identify a test failure and may involve the corresponding entity to remedy the failure. In step 210, the code may be tested with unit tests, such as narrowly-scoped tests that exercise the smallest pieces of testable code to verify proper behavior. An example of a unit test is testing a JavaScript function in the code.

In step 215, the code may be tested with component tests. For example, component tests may exercise components/modules of the code in isolation and may be limited to the scope, for example, the system that the test will be executed against (e.g., a web application, a mobile application, etc.

In step 220, the code may be tested with contract tests. For example, contract tests may test the interface(s) between integrated components in isolation to ensure that integrated components conform to a shared agreement, such as PACT, Spring Cloud Contract, etc.).

In step 225, the code may be tested with integration tests. For example, integration tests may test how different software components integrate with each other.

In step 230, the code may be deployed to an end-to-end testing environment and tested with end-to-end automation tests. For example, end-to-end automation tests may exercise the full stack of the application code, starting with an API, and may test dependent systems running in their environments.

In step 235, the code may be scanned for security issues, such as vulnerabilities, such as security flaws, glitches, or weaknesses that could be exploited by an attacker.

In step 240, if all tests are passed, the code may be deployed to a production staging environment, where, in step 245, production validation testing may be performed on the code. If the code passes the testing, the code may then be available in the production environment.

In embodiments, artificial intelligence (AI) and/or machine learning (ML) assist with testing. For example, AI and/or ML may be used for actual code testing, such as for unit tests, contract tests, etc. In one embodiment, AI and/or ML may be used to identify the test(s) needed to be performed on the code. For example, if code that failed integration testing is being re-tested after being modified, ML and/or AI may determine that the unit testing, component testing, and contract testing were successful and those tests may be skipped.

In one embodiment, a bot may be provided that incorporates AI and/or ML to manage the progression of the code through the automation pipeline, and/or to address failures. For example, a bot may be a smart test, that may be containerized with a java/selenium/cucumber wrapper, bundled with a selenium grid, to perform end-to-end functional testing in addition to non-functional requirements (e.g., Americans with Disability Act compliance, visual features, etc.). The bot may provide analytics with intelligent sensors to harness the data points which helps pin point to the actual root cause of failure.

In one embodiment, production validation tests may be set up on continuous execution on multiple threads (e.g., different browser version, different operating systems, etc.). A bot may identify failure patterns and isolate failures that are a result of the test framework, environment instability, etc., and may identify failures due to actual application code issues.

Embodiments may use AI and/or ML to implement intelligent test run scoping and orchestration. For example, a trained ML model may trigger a test execution cadence based on code update/dependencies detected. The trained ML model may be trained with historical code to predict when code should be tested.

In one embodiment, a trained machine learning engine may identify weaknesses in an application, where the largest usages of an application is, where additional testing may be needed, etc.

Embodiments may use AI and/or ML for automated production deployment and rollback.

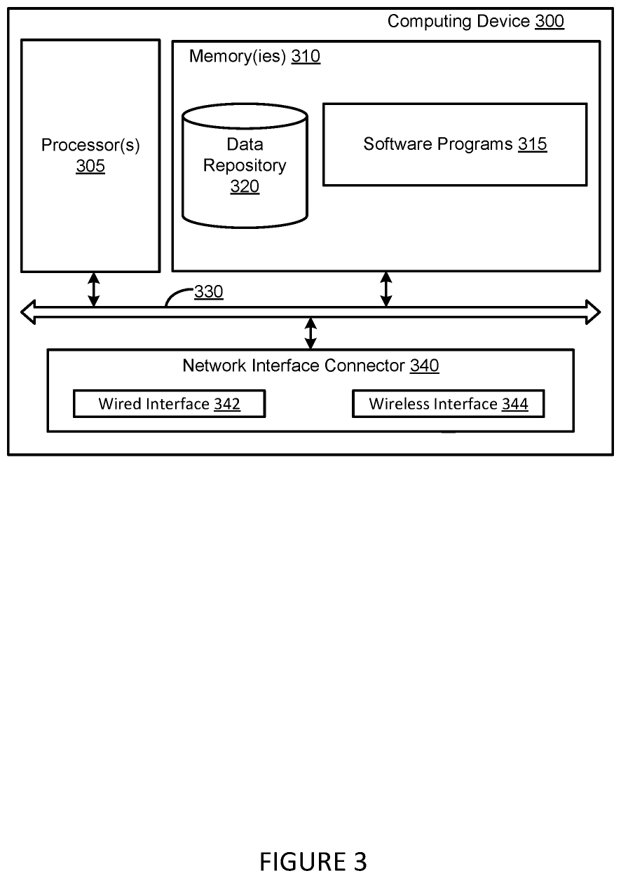

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for shift-left testing, comprising:
receiving, at an automation pipeline, code for shift-left testing, wherein the code comprises a plurality of code components;
testing, by the automation pipeline, the code with unit tests, wherein the unit tests comprise narrowly-scoped tests that exercise units of the code to verify proper behavior;
testing, by the automation pipeline, the plurality of components of the code with component tests, wherein the component tests exercise the plurality of components of the code in isolation from each other;
testing, by the automation pipeline, the code with contract tests, wherein the contract tests two code components for compatibility and communication;
testing, by the automation pipeline, the code with integration tests, wherein the integration tests integration of the plurality of components with each other;
deploying, by the automation pipeline, the code to an end-to-end testing environment and testing the code with end-to-end automation tests, wherein the end-to-end automation tests exercise the code from start to finish;
scanning, by the automation pipeline, the code for security vulnerabilities;
deploying, by the automation pipeline, the code to an end-to-end testing environment and performing production validation testing on the code, wherein the production validation testing is executed on a plurality of threads; and
deploying, by the automation pipeline, the code to a production environment.

2. The method of claim 1, wherein the component tests are limited to a system under test.

3. The method of claim 1, wherein the security vulnerabilities comprise encryption vulnerabilities and third party software development kit violations.

4. The method of claim 1, wherein the production validation testing is performed on a first browser version in a first thread, and a second browser version in a second thread.

5. The method of claim 1, wherein the production validation testing is performed on a first operating system in a first thread, and a second operating system in a second thread.

6. The method of claim 1, further comprising:
isolating, by a bot, failures due to a test framework or environmental instability from failures due to code issues.

7. The method of claim 6, wherein the bot is trained with historical data.

8. A system, comprising:
a code repository comprising code for shift-left testing, the code comprising a plurality of components;
an automation pipeline comprising a unit testing module, a component testing module, a contract testing module, an integration testing module, an end-to-end automation testing module, and a security scanning module;
an end-to-end staging environment;
a production staging environment; and
a production environment;
wherein:
the automation pipeline is configured to receive the code from the code repository;
the automation pipeline is configured to test the code with unit tests, wherein the unit tests comprise narrowly-scoped tests that exercise units of the code to verify proper behavior;
the automation pipeline is configured to test the code with component tests, wherein the component tests exercise the plurality of components of the code in isolation from each other;
the automation pipeline is configured to test the code with contract tests, wherein the contract tests two code components for compatibility and communication;
the automation pipeline is configured to test the code with integration tests, wherein the integration tests integration of the plurality of components with each other;
the automation pipeline is configured to deploy the code to the end-to-end testing environment and test the code with end-to-end automation tests, wherein the end-to-end automation tests exercise the code from start to finish;
the automation pipeline is configured to test the code for security vulnerabilities;
the automation pipeline is configured to deploy the code to the production staging environment and to perform production validation testing on the code, wherein the production validation testing is executed on a plurality of threads; and
the automation pipeline is configured to deploy the code to the production environment.

9. The system of claim 8, wherein the component tests are limited to a system under test.

10. The system of claim 8, wherein the security vulnerabilities comprise encryption vulnerabilities and third party software development kit violations.

11. The system of claim 8, wherein the production validation testing is performed on a first browser version in a first thread, and a second browser version in a second thread.

12. The system of claim 8, wherein the production validation testing is performed on a first operating system in a first thread, and a second operating system in a second thread.

13. The system of claim 8, wherein a bot executed in the automation pipeline isolates failures due to a test framework or environmental instability from failures due to code issues.

14. The system of claim 13, wherein the bot is trained with historical data.

15. A non-transitory computer readable storage medium, including instructions stored thereon, which when read and executed by one or more computer processors, cause the one or more computer processors to perform steps comprising:
receiving, from a code repository, code for shift-left testing, wherein the code comprises a plurality of code components;
testing the code with unit tests, wherein the unit tests comprise narrowly-scoped tests that exercise units of the code to verify proper behavior;
testing the plurality of components of the code with component tests, wherein the component tests exercise the plurality of components of the code in isolation from each other;
testing the code with contract tests, wherein the contract tests two code components for compatibility and communication;
testing the code with integration tests, wherein the integration tests integration of the plurality of components with each other;
deploying the code to an end-to-end testing environment and testing the code with end-to-end automation tests, wherein the end-to-end automation tests exercise the code from start to finish;
scanning the code for security vulnerabilities;
deploying the code to an end-to-end testing environment and performing production validation testing on the code, wherein the production validation testing is executed on a plurality of threads; and
deploying the code to a production environment.

16. The non-transitory computer readable storage medium of claim 15, wherein the component tests are limited to a system under test.

17. The non-transitory computer readable storage medium of claim 15, wherein the security vulnerabilities comprise encryption vulnerabilities and third party software development kit violations.

18. The non-transitory computer readable storage medium of claim 15, wherein the production validation testing is performed on a first browser version in a first thread, and a second browser version in a second thread.

19. The non-transitory computer readable storage medium of claim 15, wherein the production validation testing is performed on a first operating system in a first thread, and a second operating system in a second thread.

20. The non-transitory computer readable storage medium of claim 15, further including instructions stored thereon, which when read and executed by one or more computer processors, cause the one or more computer processors to perform steps comprising:
isolating failures due to a test framework or environmental instability from failures due to code issues.
